(19) United States
(12) Patent Application Publication
(10) Pub. No.: US 2024/0228868 A1
(43) Pub. Date: Jul. 11, 2024

(54) METHOD FOR MULTISTAGE FRACTURING OF A GEOTHERMAL WELL

(71) Applicants: NCS MULTISTAGE INC., Calgary (CA); NCS MULTISTAGE, LLC, Houston, TX (US)

(72) Inventors: Michael WERRIES, Calgary (CA); Jesse POWELL, Calgary (CA); James KING, Houston, TX (US)

(21) Appl. No.: 18/562,792

(22) PCT Filed: May 20, 2022
(86) PCT No.: PCT/CA2022/050806

§ 371 Date: Nov. 20, 2023

Related U.S. Application Data
(60) Provisional application No. 63/191,792, filed on May 21, 2021.

(51) Int. Cl. C09K 8/92; C09K 8/80; E21B 34/14; E21B 36/00; E21B 43/267; F24T 10/10

(52) U.S. Cl. CPC C09K 8/92; C09K 8/80; E21B 34/142; E21B 36/001; E21B 43/267; F24T 10/10

(57) ABSTRACT

A method is disclosed for improving heat exchange between a geothermal reservoir and a wellbore. The method comprises injecting a stimulating fluid into the reservoir at a plurality of locations along a wellbore to improve conduction of heat to the near wellbore region for circulation of a working fluid to collect reservoir heat and bring to surface for energy generation.

### FIELD OF THE INVENTION

The invention relates to multistage fracturing of a geothermal well. In particular the invention relates to fracturing the formation using thermally conductive material to improve heat harvesting efficiency in a geothermal operation.

### BACKGROUND

Geothermal energy is the thermal energy generated and stored in the Earth. A fluid is typically injected into the ground where it is heated. When the fluid is brought back to surface, the heat can be harvested. This may involve using the heat directly (e.g. to heat homes) and/or to generate electricity (e.g. using a turbine).

In a traditional geothermal system, hot water or steam is produced from a reservoir. In some systems, produced fluid directly drives a steam turbine in generation of electricity. In binary systems, heat is transferred at surface to a secondary working fluid that is used to drive a turbine to generate electricity.

More recently, Enhanced Geothermal Systems (EGS) have been installed in hot reservoirs where there may be low natural permeability or fluid saturation. In an EGS, fluid is injected down a well into the reservoir under carefully controlled conditions, which causes pre-existing fractures to re-open (and in some cases also creates new fractures within the reservoir), improving reservoir permeability. With increased reservoir permeability, a working fluid can be injected through the fractured rock, and transported through the reservoir to a production well where the heated working fluid is produced to surface.

Still further, closed loop geothermal systems have been described, otherwise known as Advanced Geothermal Systems (AGS). This typically involves the circulation of a working fluid in a closed loop through a hot reservoir to raise the temperature of the working fluid. At surface, thermal energy is transferred from the heated working fluid and converted to electricity.

The operational system may depend on the temperature of the formation, and whether or not the formation already carries a significant quantity of water.

Geothermal systems may therefore be open loop or closed loop. A closed loop geothermal system continuously circulates a heat transfer fluid through a sealed downhole conduit. The loop is filled just once and requires only a moderate amount of solution. The fluid never comes in direct contact with the formation. In contrast, in an open loop geothermal system, the fluid is directed through the formation to collect heat directly from the rocks.

In closed loop systems it is difficult to obtain enough surface area for heat exchange. Open loops are problematic because of fluid loss, corrosion, scale and so on, but have excellent heat transfer characteristics.

### SUMMARY

In accordance with the present disclosure, there is provided a method of stimulating a formation to facilitate geothermal heat harvesting comprising:
providing a conduit within a well, the conduit comprising a series of valves, each valve having one or more ports which are openable to allow fluid flow through a wall of the conduit;
performing the following steps for one or more valve of the series of valves, to create a closed loop system within the well:
   selectively opening a valve of the series of valves;
   injecting a treatment fluid through the open valve into the formation to open and fill fractures within the formation; and
   sealing the open valve to prevent further fluid communication between the formation and the conduit via the sealed valve; and
with all valves in the closed position, circulating a working fluid within the conduit to harvest heat from the formation.

It will be appreciated that after the stimulation of the formation has occurred, the order of sealing the open valve and opening the next valve may happen in either order before the next stimulation step.

The sealing of the open valve may comprise directly blocking the ports of the valve.

The sealing of the open valve may comprise blocking the conduit between the valve and the surface to prevent fluid reaching the ports from the surface.

Each of the valves may be stimulated in sequence starting from the valve farthest from the surface.

Each of the valves may be selectively controllable (e.g. openable and/or closeable) by dropping a ball or other object into the well which impinges on, and moves, one or more components of the valve to be opened. Each of the valves may be selectively controllable (e.g. openable and/or closeable) using a line from the surface (e.g. coiled tubing).

A variety of fluids may be used to create and operate the geothermal well including one or more of:
a cooling fluid used to cool the well;
a treatment fluid used to stimulate the formation; this may include specific types of fluids (e.g. a fracturing fluid for pressure induced fracturing of the formation) and/or multiple fluids injected sequentially into the formation via the conduit;
an annulus fluid used to convey materials into the annulus between the conduit and the wellbore; and
a working fluid configured to cycle between the surface and the conduit to harvest heat from the formation.

In some cases, each of these fluids will have a different composition. In others, a fluid of the same composition may be used to perform more than one of these tasks. For example, the same fluid composition may be used as both a treatment fluid to stimulate the formation, and as an annulus fluid to convey materials into the annulus.

The method may comprise circulating several well volumes of a cooling fluid to cool the well prior to injecting the treatment fluid at pressures sufficient to fracture the formation.

The treatment fluid may be a fracturing fluid.

The treatment fluid may be delivered in multiple stages. For example, an initial treatment fluid may be used to generate the fractures, and a second treatment fluid may then be injected comprising a conductive material which displaces the initial treatment fluid and forms a conductive network for conveying heat from the formation to the working fluid.

The treatment fluid may comprise a salt which is configured to be molten at downhole temperatures and pressures.

The treatment fluid used to fill the fractures during geothermal heat harvesting may have a thermal conductivity of more than 0.6 W/m·K.

The treatment fluid may comprise one or more of: tin, bismuth, NaNO₃, KNO₃ and Beryllium Oxide. The treatment fluid may comprise one or more of: LiNO₃, NaNO₂, KNO₂, MgKN, Li₂CO₃, Na₂CO₃, K₂CO₃, LiF, NaF, KF, MgCl₂, and KCl.

The treatment fluid may consist of non-aqueous materials.

The treatment fluid may comprise proppant.

The treatment fluid may comprise thermally conductive granular solid (e.g. proppant) in a carrier fluid.

The method may comprise providing a thermally conductive material within an annulus between the conduit and the well. The thermally conductive material may comprise a thermally conductive granular solid. This may be delivered by recycling an annulus fluid to convey material into the annulus between the wellbore and conduit.

A thermally conductive granular solid may comprise one or more of: diamond powder, alumina, aluminium, a thermally conductive ceramic, a thermally conductive element, a thermally conductive metal alloy.

The thermally conductive proppant may comprise particles formed of a material with a thermal conductivity of at least 10 W/m·K. The thermally conductive proppant may comprise particles formed of a material with a thermal conductivity of at least 20 W/m·K. The thermally conductive proppant may comprise particles formed of a material with a thermal conductivity of at least 50 W/m·K. The thermally conductive proppant may comprise particles formed of a material with a thermal conductivity of at least 100 W/m·K.

The treatment fluid may comprise one or more of: steel beads and conductive nano particles.

The treatment fluid may comprise solid granular material at surface which is configured to melt as it is exposed to the heat of the formation. E.g., the melting point of the salt may be lower than the temperature of the formation.

The formation may be a dry formation. This may facilitate the use of soluble molten salts.

The formation may have a temperature of at least 300° C.

The formation may have a pressure of at least 30 MPa.

A treatment fluid (e.g. a thermally conductive fluid) may injected between the conduit and formation prior to stimulating the formation.

The method may comprise removing one or more obstructions (e.g. drop balls or darts) in the conduit after stimulation is complete and prior to recycling the working fluid.

The method may comprise sealing the valves, and injecting a working fluid the conduit in a closed-loop configuration to harvest heat from the formation and return it to surface without directly contacting the formation.

The treatment fluid may be a fracturing fluid configured to create fractures in the formation when injected into the formation under pressure.

The treatment fluid may comprise an acid configured to grow fractures within the formation by dissolving portions of rock (e.g. within a limestone formation).

According to a further aspect, there is provided an apparatus for stimulating a formation to facilitate geothermal heat harvesting comprising:
a conduit, the conduit having a series of valves, each valve having ports which are openable and sealable in sequence to control fluid flow through the wall, wherein in a sealed configuration, each port is sealed using a metal-on-metal seal.

According to a further aspect, there is provided a method of stimulating a formation to facilitate geothermal heat harvesting comprising:
providing a channel from a surface within a well drilled into the formation, the channel having a wall defining a conduit for carrying fluid, and a series of valves, each valve having one or more ports which are openable to allow fluid flow through the wall;
repeatedly performing the following steps:
   selectively opening a valve of the series of valves adjacent to a region of the formation which has not yet been stimulated;
   injecting a treatment fluid through the open valve into the formation to stimulate and fill fractures within the formation; and
   sealing the open valve to prevent fluid passing from the surface to the formation via the sealed valve; and
recycling a working fluid through the channel to harvest heat from the formation.

According to a further aspect, there is provided a method of stimulating a formation to facilitate geothermal heat harvesting comprising:
providing a conduit within a well, the conduit comprising a series of valves, each valve having one or more ports which are openable to allow fluid flow through the wall;
providing a thermally conductive material within an annulus between the conduit and the well;
performing the following steps for one or more valve of the series of valves, to create a closed loop system within the well:
   selectively opening a valve of the series of valves;
   injecting a treatment fluid through the open valve into the formation to open and fill fractures within the formation; and
   sealing the open valve to prevent further fluid communication between the formation and the conduit via the sealed valve; and
circulating a working fluid within the conduit to harvest heat from the formation.

The thermally conductive material may comprise a granular solid.

According to a further aspect, there is provided a method of stimulating a formation to facilitate geothermal heat harvesting comprising:
providing a conduit within a well, the conduit comprising a series of valves, each valve having one or more ports which are openable to allow fluid flow through the wall;
performing the following steps for one or more valve of the series of valves:
   selectively opening a valve of the series of valves;
   injecting a treatment fluid through the open valve into the formation to open and fill fractures within the formation, wherein the treatment fluid comprises a thermally conductive granular solid; and
   sealing the open valve to prevent further fluid communication between the formation and the conduit via the sealed valve;
unsealing the valves to permit fluid flow between the conduit and the formation; and
circulating a working fluid within the conduit and the fractures to harvest heat from the formation.

Metal-on-metal seals are particularly useful in high-temperature operations in which other materials (e.g. plastics or elastomers) lose their useful properties. The valves may be considered to be high-temperature valves. The valves and seals may be used at temperatures of 320° C. and above. The valves and seals may be used at temperatures of up to 600° C. or higher.

The treatment fluid may be thermally conductive. Under downhole conditions, the thermally conductive material may have a viscosity greater than that of water. This may help prevent the thermally conductive material migrating away from the conduit after it has been injected. The treatment fluid may comprise a liquid having a viscosity of at least 0.001 pascal-second across a temperature range of 0-320° C. (e.g., including above the melting point of the salt). The treatment fluid may comprise a liquid having a viscosity of at least 0.001 pascal-second under steady state formation temperatures and pressures. This ensures that proppant can be supported all the way from the surface to the formation.

The treatment fluid may have a heat capacity of more than 1.5 J/g·K. A molten salt used as part of the treatment fluid may have a heat capacity of more than 1.5 J/g·K in a molten state. A molten salt used as part of the treatment fluid may have a heat capacity of more than 1 J/g·K in a molten state. Using materials with a higher heat capacity and a high conductivity would allow the treatment fluid within the fractures to store heat from the formation (e.g. when the working fluid is not being circulated) and then quickly transferred to the working fluid when it is required.

The treatment fluid may be a non-aqueous fluid.

The treatment fluid may have a density of at least 1.5 g/cm³ at 20° C. and atmospheric pressure.

The treatment fluid may comprise molten salt with a density of at least 1.5 g/cm³. Using a higher density liquid may facilitate carrying particulates such as proppant or conductive particles.

The treatment fluid may comprise one or more of: sand and resin.

The treatment fluid may comprise a Low Melting Point (LMP) salt (e.g. mixture of 60% NaNO₃ and 40% KNO₃). A low melting point salt may be a salt with a melting point below 350° C. The treatment fluid may comprise a High Melting Point (HMP) salt. A high melting point salt may be a salt with a melting point greater than 350° C. and up to 4350° C. or higher. The melting point of the salt may be less than the that of the formation.

The treatment fluid may comprise Beryllium Oxide. The treatment fluid may comprise metal bead proppant. Using a metal proppant may improve thermal conductivity.

The treatment fluid may comprise prills of molten salt or pelletized molten salt. A prill is a small aggregate or globule of a material, most often a dry sphere, formed from a melted liquid.

The treatment fluid may be configured to solidify in the fractures within the formation.

The formation may be hot. The formation may be at least 320° C. The formation may be less than 600° C. The formation may be a dry formation. A dry formation may not contain significant quantities of water. A dry formation may not contain significant quantities of liquid.

The conduit and valves may be formed entirely of metal. The conduit and valves may not comprise plastic or elastomers.

Sliding sleeves may be configured to form a metal-metal seal to prevent fluid passing between the sleeves.

The conduit may comprise metal packers (e.g. open hole packers).

The conduit may comprise a plurality of branches. The conduit may have a fishbone structure.

According to a further aspect, there is provided a method for improving heat exchange between a geothermal reservoir and a wellbore, the method comprising: injecting a thermally conductive fracturing fluid into the reservoir at a plurality of locations along a wellbore to improve conduction of heat to the near wellbore region for circulation of a working fluid to collect reservoir heat and bring to surface for energy generation.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1a is a cross-section of a closed-loop embodiment of a conduit configured to fracture a formation at various points along its length.

FIG. 1b is a cross-section of the embodiment of FIG. 1a after the formation has been fractured, and a pipe has been inserted into the conduit to allow a working fluid to be injected into and recovered from the same conduit.

FIG. 1c is a cross-section of the embodiment of FIG. 1a after the formation has been fractured, and the conduit has been connected to another conduit to allow a working fluid to be injected into one conduit and recovered from the other conduit.

FIG. 2 is a cross-section of an open-loop embodiment of a conduit configured to fracture a formation at various points along its length.

FIG. 3 is a flow diagram of the method used to fracture a formation.

### DETAILED DESCRIPTION

### Introduction

Any geothermal system in which a working fluid is injected into a formation, heated by the formation, and then recovered is limited by the rate at which heat can be transmitted from the formation to the working fluid. For example, in a closed-loop system, the surface area and conductivity of the conduit limits the rate at which heat is transmitted from the formation to the working fluid.

In other embodiments, the rock itself may restrict the flow of heat by acting effectively as a thermal insulator.

One solution to the issue of the inherent low conductivity of the rock formation itself is to create a network of thermally conductive pathways through the reservoir by creating fractures through the formation. This increases the surface area through which heat can be harvested and forms a network of thermal conduits through which heat can be directed to the working fluid when the geothermal system is operational. Even in a closed loop system, the fractures may be filled with thermally conductive material to direct heat towards the working fluid.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention.

### Closed Loop System

A number of possible alternative features are introduced during the course of this description. It is to be understood that, according to the knowledge and judgment of persons skilled in the art, such alternative features may be substituted in various combinations to arrive at different embodiments of the present invention.

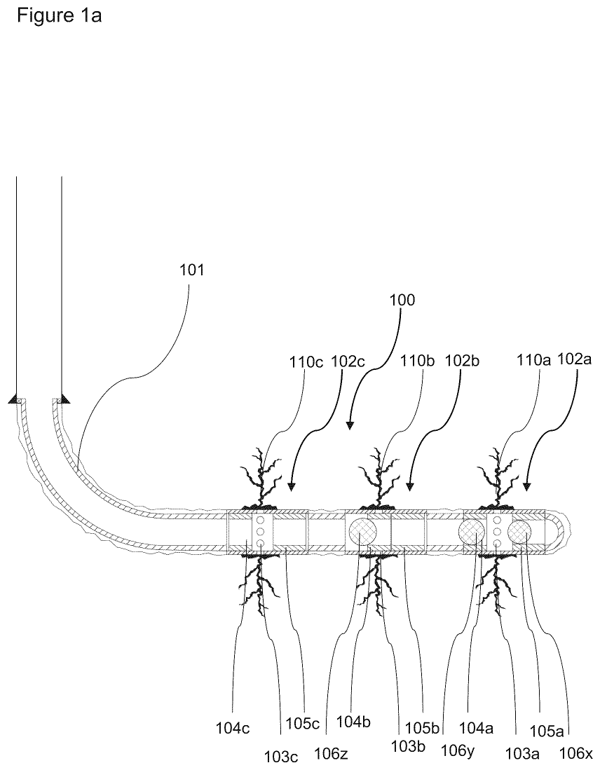

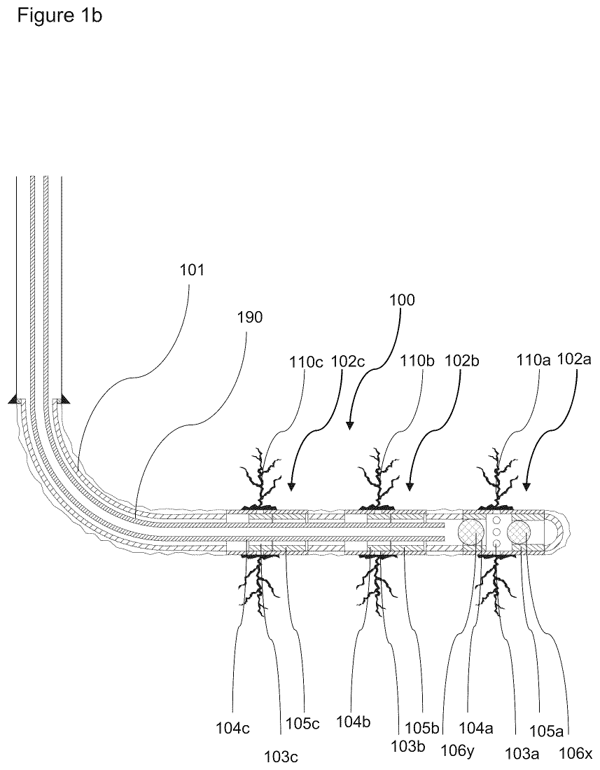

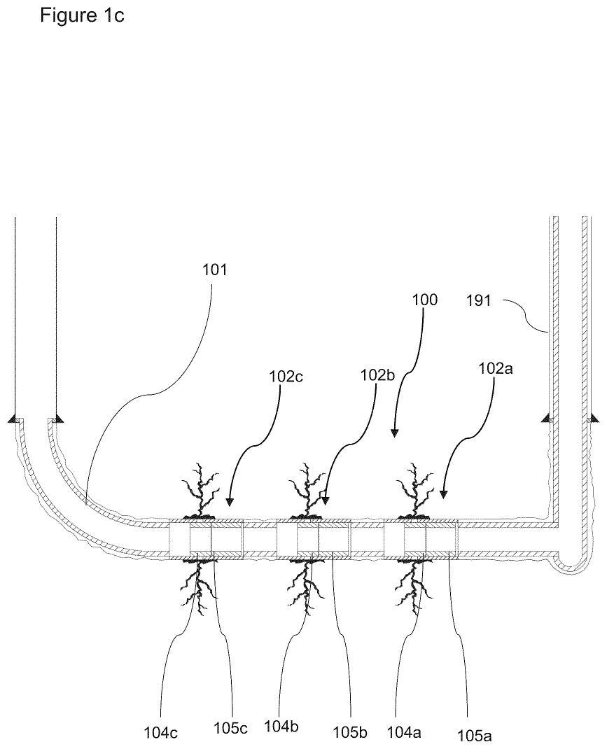

FIG. 1a is a cross-sectional diagram of an apparatus for fracturing a formation in order to facilitate geothermal heat harvesting.

In this case, FIG. 1a shows a conduit 100 inserted into place within the well through which fluid can flow from the surface. The conduit comprises a wall 101.

The conduit 100 in this case comprises three valves, a proximal valve 102c, a middle valve 102b and a distal valve 102a. Each valve comprises a number of ports 103a-c through the wall of the conduit. When open, these ports facilitate fluid flow through the wall between the conduit and the formation.

In this case, each valve 102a-c comprises two sleeves: a top sleeve 104a-c and a bottom sleeve 105a-c. When the conduit is inserted, the sleeves are in their upper position (i.e. closer to the surface than to the toe of the conduit within their respective range of travel). Each bottom sleeve 104a-c is configured directly to block the ports of the valve when in an upper position, and not block the ports when in the lower position.

For the proximal and middle valves 102b,c, each top sleeve 105a-b is configured not to block the ports when in an upper position, and directly block the ports when in a lower position. Therefore, the proximal and middle valves have three configurations: an initial configuration when both sleeves are in the upper positions, and the bottom sleeve is blocking the ports; an open configuration when the top sleeve is in an upper configuration and the bottom sleeve is in a lower position; and a resealed configuration when both the top and bottom sleeves are in the lower position, and the top sleeve is blocking the ports.

For the distal valve 102a, the top sleeve is fixed and does not move in this embodiment. Instead, it provides a fixed seat for a ball which can be used to seal off the ports of the distal valve. It will be appreciated that other embodiments may use a sliding top sleeve in the distal valve or simply have a fixed seat for the ball drop.

Because this embodiment relies on sliding sleeves, and the temperature of the formation is high, there is a possibility that the sliding sleeves may be heated sufficiently to cause an interference fit between the sliding sleeves and the conduit wall. To counteract this, the first step is to circulate several well volumes of low-temperature fluid (e.g. surface temperature or 20° C. or less) through the well to cool the conduit and sleeves. In other embodiments the material of the sleeve may be chosen with a thermal expansion coefficient less than or equal to that of the wall.

In this case, the sleeves are controlled using successive ball drops. Other embodiments may use darts. It will be appreciated that the sleeves inner diameters may decrease away from the surface such that as larger balls are dropped, each sleeve can be activated in order starting with the farthest one away from the surface, and moving successively towards the surface. Other embodiments may include valves which are controlled using coiled tubing or wireline shifting.

First a smallest first ball 106x is dropped in order to open the bottom sleeve 105a of the distal valve 102a. This changes the distal valve 102a into the open configuration, while the other two valves 102b,c remain closed in their initial positions. The first ball also seals off the toe of the conduit.

The formation is then fractured by injecting a treatment fluid through the distal valve into the formation to fracture the formation and fill the created fractures 110a with the treatment fluid. The treatment fluid in this case is thermally conductive and forms a conductive network of fractures in and around the formation to better harvest heat. The treatment fluid may comprise a conductive molten salt and/or a conductive granular solid (e.g. to act as a proppant).

Then a larger second ball 106y is dropped into the conduit. In this embodiment, the second ball first engages with the bottom sleeve 105b of the middle valve 102b and moves it to a lower position which places the middle valve into an open configuration. When the bottom sleeve of the middle valve has been placed in a lower position it releases the ball 106y, and the ball passes through the bottom sleeve 105b to engage with the top sleeve 104a of the distal valve 102a and it stays there without moving the sleeve 104a. That is, the top sleeve 104a acts as a fixed seat for the ball 106y. The ball therefore effectively blocks the conduit and prevents fluid flow from the surface reaching the ports 103a of the distal valve 102a.

After the second ball has reached its final position, the proximal valve 104c is in its initial configuration (ports directly blocked by bottom sleeve 105c), the middle valve 104b is in an open configuration (ports open) and the distal valve 104a is in a resealed configuration (ports indirectly blocked by ball 106x).

The formation is then fractured at a different location by injecting a treatment fluid through the open middle valve 102b into the formation to fracture the formation and fill the created fractures 110b with a thermally conductive material.

Then an even larger third ball 106z is dropped into the conduit. The third ball first engages with the bottom sleeve 105c of the proximal valve 102c and moves it to a lower position which places the proximal valve into an open configuration. When the bottom sleeve of the proximal valve has been placed in a lower position it releases the ball, and the ball passes through the bottom sleeve to engage with the top sleeve 104b of the middle valve 102b, moving it to a lower position where it reseals the ports of the distal middle.

The formation is then fractured at a different location by injecting a treatment fluid through the proximal valve 102c into the formation to fracture the formation and fill the created fractures 110c with the thermally conductive material. This is the situation shown in FIG. 1a.

It will be appreciated that a conduit may comprise more than three valves, and the process could be repeated to fracture the formation at multiple further locations. Other embodiments may have two valves.

When all the valves have been used for fracturing, one or more of the balls 106x-z are removed. This can be by flowing them back, dissolving them, melting them (e.g. using the heat of the formation) or milling them out. Depending on the configuration, the first and/or second balls 106x-y at the end of the conduit may or may not be removed. In some embodiments, it may be kept in place to block the end of the conduit, and prevent working fluid entering the formation via the distal valve.

In this embodiment, as shown in FIG. 1b, to harvest heat from the formation, a pipe 190 is inserted into the conduit until it approaches the toe forming a coaxial arrangement with the conduit wall. A working fluid (e.g. water) is injected into the pipe-conduit annulus between the pipe and the conduit. As the working fluid moves through the horizontal section of the conduit it is heated by the formation. Heat is directed to the conduit wall by the fractured network of thermally conductive material within the formation. This heat then passes through the conduit wall 101 and into the working fluid. The heated fluid is then recovered to surface via the pipe. At surface, the heated fluid may be used to power a steam turbine in order to generate electricity.

It will be appreciated that the working fluid may also be circulated in the opposite direction by being pumped into the pipe and recovered via the pipe-conduit annulus. This may allow a pump to be placed within the pipe (e.g. downhole near the surface) to circulate the working fluid, which may be easier to operate.

Because the valves are all resealed, the working fluid is restricted from coming in direct contact with the formation or the fractured network containing the treatment fluid. That is, this embodiment is a closed-loop system. Because the conduit was cooled initially, when the conduit is being used in normal geothermal operations, it may be hotter than when it was being used to convey treatment fluids. This hotter temperature may allow the sleeves directly blocking the ports to form an interface fit with the conduit wall around the ports, thereby providing a better seal. The seal may be a metal-metal seal.

The pipe and/or conduit may comprise vacuum insulated tubing (VIT) towards the top (corresponding to the cooler vertical portion of the well). This prevents the working fluid being cooled as it approaches the surface.

In other embodiments, one well may be connected to another well so that the working fluid can be injected into one well and recovered at another well. This removes the need to accommodate opposing flows within a single conduit portion. An example of this is shown in FIG. 1c where another well 191 has been drilled to connect with the toe of the conduit.

### Open Loop System

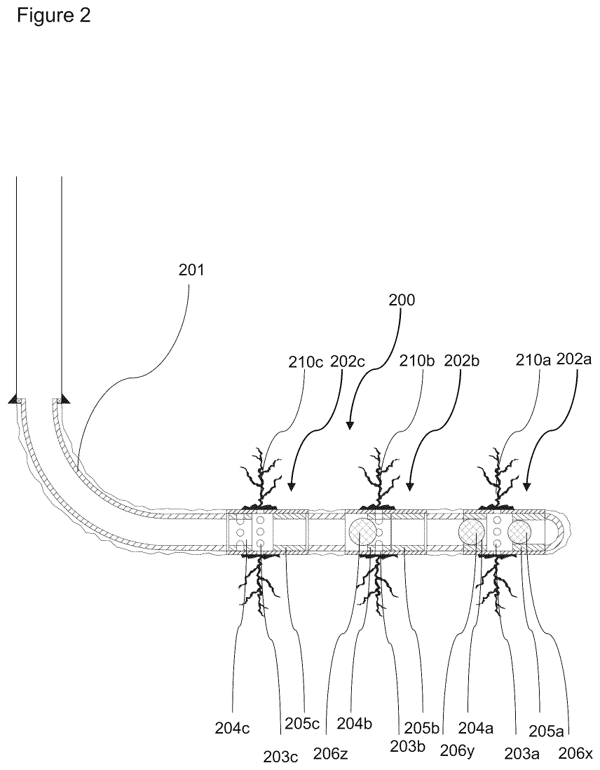

FIG. 2 is a cross-sectional diagram of a further apparatus for fracturing a formation in order to facilitate geothermal heat harvesting.

In this case, FIG. 2 shows the conduit 200 inserted into place within the well. The conduit comprises a wall 201.

As in the previous embodiment, the conduit in this case comprises three valves, a proximal valve 202c, a middle valve 202b and a distal valve 202a. Each valve comprises a number of ports 203a-c through the wall of the conduit. When open, these ports facilitate fluid flow through the wall between the conduit and the formation.

Like the previous embodiment, each valve comprises two sleeves: a top sleeve 204a-c and a bottom sleeve 205a-c. When the conduit is inserted, the sleeves are in their upper position (i.e. closer to the surface than to the toe of the conduit). Each bottom sleeve is configured directly to block the ports of the valve when in an upper position, and not block the ports when in the lower position.

Each top sleeve is configured to not block the ports when in an upper position but, in contrast to the previous embodiment, each top sleeve of the proximal and middle valves 202a-b is configured to restrict flow through the ports when in a lower position. That is, the upper sleeve comprises holes which are smaller than the ports. Restricting the flow allows fluid injected into the conduit to be more evenly distributed across all the valves when harvesting heat from the geothermal formation in an open loop system. In contrast, if the valves are unrestricted, and one fracture has less resistance to fluid flow than the others, fluid will preferentially flow through the low resistance fracture and limit the rate at which heat can be harvested from the formation.

Therefore, the proximal and middle valves 202a,b each has three configurations: an initial configuration when both sleeves are in the upper positions, and the bottom sleeve 205a,b is blocking the ports; an open configuration when the top sleeve 204a,b is in an upper configuration and the bottom sleeve 205a,b is in a lower position; and a restricted configuration when both the top and bottom sleeves are in the lower position, and the top sleeve 204a,b is restricting, but not blocking, the ports.

As before, because this embodiment relies on sliding sleeves, and the temperature of the formation is high, the first step is to circulate several well volumes of low-temperature fluid (e.g. surface temperature or 20° C. or less) through the well to cool the conduit and sleeves.

As in the previous embodiment, first a smallest first ball 206x is dropped in order to lower the bottom sleeve 205a of the distal valve 202a. This changes the distal valve 202a into the open configuration, while the other two valves 202a,b remain closed in their initial position. The first ball 206x also seals off the toe of the conduit.

The formation is then fractured by injecting a treatment fluid through the distal valve 202a into the formation to create fractures 110 in the formation. In this case, the treatment fluid comprises a thermally conductive granular solid. The thermally conductive granular solid may be act as, or be mixed with, a proppant. In this way, the thermally conductive solid forms a conductive solid network within the fractures to facilitate heat flow from the formation to the working fluid.

Then a larger second ball 206y is dropped into the wellbore. In this embodiment, the second ball first engages with the bottom sleeve 205b of the middle valve 202b and moves it to a lower position which places the middle valve 202b into an open configuration. When the bottom sleeve 205b of the middle valve has been placed in a lower position it releases the ball, and the ball 206y passes through the bottom sleeve 205b to engage with the top sleeve 204a of the distal valve 202a. The distal valve in this embodiment has a fixed top sleeve 204a which acts as a fixed seat for the ball 206y. With the ball 206y in place, fluid is prevented form passing from the surface into the formation by the ball.

After the second ball 206y has reached its final position, the proximal valve 202c is in its initial configuration (ports blocked by bottom sleeve 205c), the middle valve 202b is in an open configuration (ports open) and the ports of the distal valve 202b are blocked by the second ball 206y.

The formation is then fractured at a different location by injecting a treatment fluid through the open middle valve 202b into the formation create fractures 210b in the formation. Because the second ball 206y stops fluid passing through the already fractured distal valve, the pressure of the fluid within the conduit is directed towards the middle valve. As with the previous valve, the treatment fluid comprises a thermally conductive granular solid to help conduct heat within the fractures.

Then an even larger third ball 206z is dropped into the conduit. The third ball 206z first engages with the bottom sleeve 205c of the proximal valve 202c and moves it to a lower position which places the proximal valve into an open configuration. When the bottom sleeve 205c of the proximal valve 202c has been placed in a lower position it releases the ball, and the ball 206z passes through the bottom sleeve 205c to engage with the top sleeve 204b of the middle valve 202b, moving it to a lower position where it restricts the ports of the distal middle. As before, the ball 206z itself prevents fluid flow from the surface to the restricted ports 203b.

The formation is then fractured at a different location by injecting a treatment fluid through the proximal valve 202c into the formation to create fractures 210c in the formation. As with the previous valve, the treatment fluid comprises a thermally conductive granular solid to help conduct heat within the fractures. This is the situation shown in FIG. 2.

It will be appreciated that a conduit may comprise more than three valves, and the process could be repeated to fracture the formation at multiple further locations.

When all the valves have been fractured, the balls are removed. This can be by flowing them back, dissolving them or milling them out. Depending on the configuration, the first and/or second balls 206x,y at the end of the conduit may or may not be removed. In some embodiments, they may be kept in place to block the end of the conduit.

In this embodiment, to harvest heat from the formation, a working fluid (e.g. water) is injected into the conduit where it can enter the formation via the restricted valves. That is, this embodiment is configured to operate in an open configuration. That is, in this embodiment, this conduit is acting as an injection well. It will be appreciated that this well may be used as a recovery well configured to receive working fluid from the formation and deliver it to the surface.

The open loop configuration allows the working fluid to directly contact with the formation, and it can be recovered using another recovery well. As the working fluid is injected, it can pass in and around the thermally conductive granular solid (at either or both of the production and recovery wells) which helps the efficiency of heat harvesting.

In other embodiments, a thermally conductive granular solid may also be placed around the conduit (e.g. between the valves) to help collect heat directly from the wellbore. The thermally conductive granular solid may be placed around the conduit by injecting an annulus fluid through the open valves prior to or during fracturing (and possibly prior to setting the packers of the conduit). Alternatively or in addition, the thermally conductive granular solid may be placed around the conduit by being ejected through an open toe of the conduit prior to fracturing.

The conduit of the recovery well may comprise VIT towards the top (corresponding to the cooler vertical portion of the well). This prevents the working fluid being cooled as it approaches the surface.

### Installation of Conduit

There are a variety of options for installing the conduit. The two embodiments described above each have a closed toe conduit. This means that the conduit can be run into the well and then a setting fluid injected into the well directly to increase the pressure within the conduit and set hydraulic packers which engages with the formation to hold the conduit in place.

Another option is to insert an open toe conduit (i.e. where the conduit is open at the distal end). This allows fluid to be removed from the well through the conduit as it is being inserted. In this option, after the conduit is fully inserted into the well, a ball or dart or other isolation mechanism is typically inserted to seal the toe. The ball or dart may initially rest in the bottom sleeve of the distal valve. This allows a pressure to be applied within the conduit to set hydraulic packers to secure the conduit to the formation. The pressure may be maintained to confirm set and to perform any required pressure tests.

Increasing the pressure further may allow the ball, dart or other isolation mechanism to move the bottom sleeve of the distal valve to open a flow path to the formation and permit fracturing of the formation.

Another advantage of the open toe conduit option while inserting the conduit is that it allows an annulus fluid to be recycled outside the conduit within the wellbore annulus (i.e. between the outside of the conduit and the formation). For example, thermally conductive fluid can be injected to position a layer of thermally conductive material around the conduit before fracturing is performed. This may be done by injecting the thermally conductive fluid into the conduit and recovering any excess via the wellbore annulus formed between the outside of the conduit and the formation, or by injecting the thermally conductive fluid into the wellbore annulus formed between the outside of the conduit and the formation and recovering any excess from the conduit.

### Method

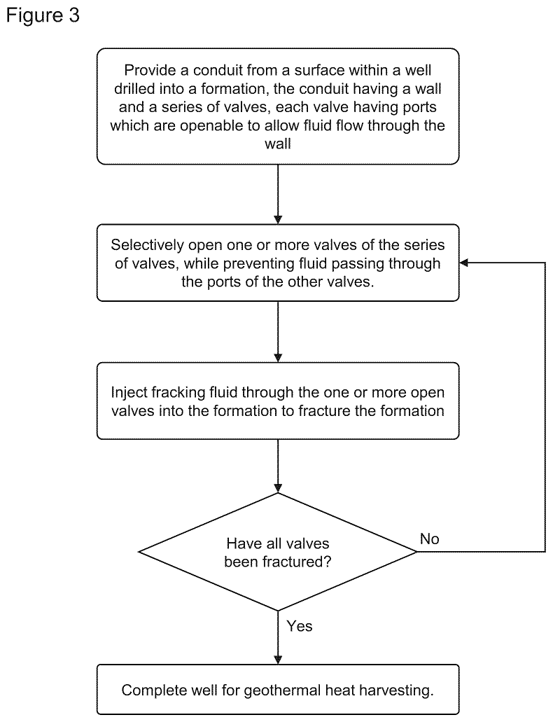

FIG. 3 summarizes the method used in the embodiments of FIGS. 1 and 2.

First a conduit is provided from a surface within a well drilled into a formation, the conduit having a wall defining a conduit, and a series of valves, each valve having ports which are openable to allow fluid flow through the wall.

Then one or more valves are selectively opened while the rest remain closed or blocked from receiving fluid from the surface.

Then a treatment fluid is injected through the one or more open valves into the formation to fracture the formation.

Valves are then opened and closed until all the valves required have been fractured.

Lastly the well is completed to facilitate the harvesting of geothermal heat.

### Treatment Fluid

The treatment fluid that is used should have a number of properties depending on the type of stimulation (e.g. fracturing or acid stimulation) and the type of geothermal operation (e.g. open or closed loop).

In some embodiments, the treatment fluid is configured to conduct heat from the formation towards the conduit to facilitate heat harvesting from the formation. In addition, it may be configured to be in a liquid or solid state under downhole conditions. This helps ensure that the treatment fluid remains in place within the fractures and does not migrate away over time. The treatment fluid may have a thermal conductivity of at least 0.5 W/m·K. The treatment fluid comprises one or more of: steel beads and conductive nano particles.

In addition, the treatment fluid may be configured to be sufficiently viscous so that it can carry proppant (which itself may be thermally conductive) and other granular materials from the surface into the fractures. This is affected by pumping rate so the rate may be adjusted to ensure that the treatment fluid can support the proppant to the formations.

The treatment fluid may be a mixture of granular solids and liquids which can flow within the conduit.

### Options

The conduit can be connected to another conduit which also provides a pathway to surface. These connected conduits may provide a closed loop circulation pathway for a working fluid to be injected into one conduit and recovered from the other conduit. The conduits may be connection by connecting a horizontal well to a vertical well or by connecting to horizontal wells toe to toe.

The conduit may comprise a single surface opening. The working fluid may be injected into the well at this opening and retrieved at the same opening. For this arrangement, the conduit may be configured to house an injection portion to inject working fluid into the well and a separate return portion to allow the working fluid to return to the surface. This may be facilitated by having two pipes within the conduit, or using coaxial tubing.

Although the present invention has been described and illustrated with respect to preferred embodiments and preferred uses thereof, it is not to be so limited since modifications and changes can be made therein which are within the full, intended scope of the invention as understood by those skilled in the art.

1. A method of stimulating a formation to facilitate geothermal heat harvesting comprising:
providing a conduit within a well, the conduit comprising a series of valves, each valve having one or more ports which are openable to allow fluid flow through a wall of the conduit;
performing the following steps for one or more valve of the series of valves, to create a closed loop system within the well:
selectively opening a valve of the series of valves;
injecting a treatment fluid through the open valve into the formation to open and fill fractures within the formation; and
sealing the open valve to prevent further fluid communication between the formation and the conduit via the sealed valve; and
with all valves in the closed position, circulating a working fluid within the conduit to harvest heat from the formation.

2. The method of claim 1, wherein the sealing of the open valve comprises closing the ports of the valve by shifting a sliding sleeve to directly block the ports.

3. The method according to claim 1, wherein the sealing of the open valve comprises blocking the conduit between the valve and the surface by seating a sealing member within the sleeve.

4. The method according to claim 1 wherein each of the valves is configured to be selectively opened by dropping a ball, shifting tool or other object into the well which impinges on, and moves, one or more components of the valve to be opened.

5. The method according to claim 1 wherein the method comprises circulating several well volumes of a cooling fluid to cool the well prior to injecting the treatment fluid at pressures sufficient to fracture the formation.

6. The method according to claim 1 wherein the treatment fluid comprises a salt which is configured to be molten at downhole temperatures and pressures.

7. The method according to claim 1 wherein the treatment fluid has a thermal conductivity of more than 0.6 W/m·K.

8. The method according to claim 1 wherein the treatment fluid comprises one or more of: tin, bismuth, NaNO₃, KNO₃ and Beryllium Oxide.

9. The method according to claim 1 wherein the treatment fluid consists of non-aqueous materials.

10. The method according to claim 1 wherein the treatment fluid comprises proppant.

11. The method according to claim 1 wherein the treatment fluid comprises thermally conductive proppant in a carrier fluid, the thermally conductive proppant being formed of a material with a thermal conductivity of at least 10 W/m·K.

12. The method according to claim 1 wherein the treatment fluid comprises one or more of: steel beads, conductive nano particles, thermally conductive powder, thermally conductive beads; thermally conductive ceramics, thermally conductive elements, a metal, diamond, alumina, aluminum, tungsten, and graphite.

13. The method according to claim 1 wherein the treatment fluid comprises solid granular material at surface which is configured to melt as it is exposed to the heat of the formation.

14. The method according to claim 1 wherein the formation is a dry formation.

15. The method according to claim 1 wherein the formation has a temperature of at least 300° C.

16. The method according to claim 1 wherein the formation has a pressure of at least 30 MPa.

17. The method according to claim 1 wherein a thermally conductive fluid is injected between the conduit and formation prior to stimulating the formation.

18. The method according to claim 17 wherein the thermally conductive fluid has a different composition then the treatment fluid.

19. The method according to claim wherein the valves are sealed, and a working fluid is injected into the conduit in a closed-loop configuration to harvest heat from the formation and return it to surface without directly contacting the formation.

20. The method according to claim 1 wherein the treatment fluid is a fracturing fluid configured to create fractures in the formation when injected into the formation under pressure.

21. The method according to claim 1 wherein the treatment fluid comprises an acid configured to grow fractures within the formation by dissolving portions of rock.

22. An apparatus for stimulating a formation to facilitate geothermal heat harvesting comprising:
a conduit, the conduit having a series of valves along its length, each valve having ports which are openable and sealable in sequence to control fluid flow through the wall, wherein in a sealed configuration, each port is sealed using a metal-on-metal seal.

23. A method of stimulating a formation to facilitate geothermal heat harvesting comprising:
providing a conduit within a well, the conduit comprising a series of valves, each valve having one or more ports which are openable to allow fluid flow through a wall of the conduit;
providing a thermally conductive material within an annulus between the conduit and the well;
performing the following steps for one or more valve of the series of valves, to create a closed loop system within the well:
selectively opening a valve of the series of valves;
injecting a treatment fluid through the open valve into the formation to open and fill fractures within the formation; and
sealing the open valve to prevent further fluid communication between the formation and the conduit via the sealed valve; and
circulating a working fluid within the conduit to harvest heat from the formation.

24. The method of claim 23, wherein the thermally conductive material comprises a granular solid.

25. A method of stimulating a formation to facilitate geothermal heat harvesting comprising:
providing a conduit within a well, the conduit comprising a series of valves, each valve having one or more ports which are openable to allow fluid flow through a wall of the conduit;
performing the following steps for one or more valve of the series of valves:
selectively opening a valve of the series of valves;
injecting a treatment fluid through the open valve into the formation to open and fill fractures within the formation, wherein the treatment fluid comprises a thermally conductive granular solid; and
sealing the open valve to prevent further fluid communication between the formation and the conduit via the sealed valve;
unsealing the valves to permit fluid flow between the conduit and the formation; and
circulating a working fluid within the conduit and the fractures to harvest heat from the formation.

26. The method of claim 25, wherein the method comprises providing a thermally conductive granular solid within an annulus between the conduit and the well.

27. The method according to claim 25, wherein the method comprises providing a second conduit within a second well, wherein both conduits are in fluid communication with each other through the formation, wherein circulating the working fluid comprises injecting the working fluid into one of the conduits and recovering the working fluid at the other conduit.
